(19) United States
(12) Patent Application Publication
(10) Pub. No.: US 2014/0174846 A1
(43) Pub. Date: Jun. 26, 2014

(54) PROTECTIVE CASE FOR A MOBILE DEVICE AND SOUND AMPLIFICATION FEATURE THEREOF

(71) Applicant: Michael Molinaro, New York, NY (US)

(72) Inventor: Michael Molinaro, New York, NY (US)

(21) Appl. No.: 14/079,542

(22) Filed: Nov. 13, 2013

Related U.S. Application Data
(60) Provisional application No. 61/725,721, filed on Nov. 13, 2012.
(60) Provisional application No. 61/865,951, filed on Aug. 14, 2013.
(60) Provisional application No. 61/804,461, filed on Mar. 22, 2013.

(51) Int. Cl. H04B 1/38; G10K 11/08

(52) U.S. Cl. CPC H04B 1/3888; G10K 11/08
USPC 181/177

(57) ABSTRACT

Protective cases for use with mobile devices (phones and tables) are disclosed herein and include a sound amplification feature which is integral to the case and serves to amplify the sound emitted from the speaker of the mobile device.

### CROSS-REFERENCE TO RELATED APPLICATION

This patent application is based on and claims priority to U.S. Provisional Patent Application Ser. No. 61/725,721, filed on Nov. 13, 2012, and U.S. Provisional Patent Application Ser. No. 61/865,951, filed Aug. 14, 2013, the entire contents of which are expressly incorporated by reference herein.

### BACKGROUND

Portable mobile devices have become ever increasingly popular and have become a mainstream. There are a number of different types of mobile devices with some of the more popular being mobile (cellular) phones, tablets, digital players (MP3 players), etc. In order to protect these portable devices from being damaged (e.g., scratched), different types of protective sleeves are on the market and generally fit around and are attached to the mobile device. These protective sleeves are typically formed of plastic, rubber, silicone, synthetic leather, or natural leather to cover the outer surfaces of the mobile device.

When a user intends to listen to the audio output of the mobile device, the user can either insert an earphone plug into an audio port or the user can utilize a load speaker built into the mobile device. However, the sound amplifying effect of the built-in loud speaker of the portable mobile device is insufficient. Unfortunately, traditional protective sleeves do not provide any sound amplification effect.

There is therefore a need for a protective case or sleeve that not only protects the mobile device but also is constructed to provide a sound amplification effect with respect to the built-in speaker thereof.

### SUMMARY

Protective cases for use with mobile devices (phones and tables) are disclosed herein and include a sound amplification feature which is integral to the case and serves to amplify the sound emitted from the speaker of the mobile device.

The cases of the present invention provide a number of advantages including but not limited to: (a) even though the case has a built in acoustic chamber it includes a protective lip around face of phone offering the same protection for the phone as any standard phone protection case; (b) unlike previous design by others the improved case of present invention is streamlined and not overbearing and cumbersome. It is discreet and comfortable and makes it so that the phone easily fits into a pocket; (c) unlike previous design the present case captures, diverts and focuses the sound from the phones speaker through our (basically) sealed chamber and through acoustically favorable, strategically placed and patterned holes in the back, side, or front of the case. These holes and slim case design style causes sound to remain in a closed space between the case and phone/tablet which reduces diffraction of sound to ensure a higher quality of sound emitted from case. Optimal sound and quality are achieved through sound voids of 1 mm-3.5 mm. Anymore ear piercing diffraction will occur; and (d) the multiple piece case is clearly a different way of building the acoustic cavity.

### BRIEF DESCRIPTION OF THE DRAWING FIGURES

FIGS. 1A-1H show another exemplary mobile device case;

FIGS. 2A-2H show another exemplary mobile device case;

FIGS. 3A-3H show another exemplary mobile device case;

FIGS. 4A-4D show another exemplary mobile device case;

FIGS. 5A-5E show another exemplary mobile device case;

FIGS. 6A-6F show another exemplary mobile device case;

FIGS. 7A-7E show another exemplary mobile device case; and

FIGS. 8A-8D show another exemplary mobile device case.

### DETAILED DESCRIPTION OF THE DRAWING FIGURES

In accordance with the present invention, a protective sleeve or case is provided for use with a mobile device or portable electronic device. The mobile device can be in the form of any number of different portable or mobile electronic devices that include an internal (built-in) speaker. For example, the mobile device can be in the form of a mobile (cellular) phone, a tablet, a PDA, portable media player, etc. As is known, the internal speaker acts as a loudspeaker in accordance with one operating mode of the mobile device. Another operating mode of the mobile device utilizes headphones plugged into a headphone jack.

The mobile device can be in the form of a mobile (cellular) phone. The mobile device includes a first end, an opposing second end, a first side, an opposing second side, a front face and an opposite rear face. The front face includes a display screen, such as a touch screen. The mobile device can include a number of buttons and inputs, such as a power on button and an input port that can act not only as a charging port but also serves as a means for downloading content to the device and uploading content from the device. One type of input port is a USB input. The mobile device also includes a headphone jack and a built-in speaker. In the illustrated mobile device, the input port (USB) is adjacent the speaker and are located at second end. However, it will be understood that this is merely one exemplary location for the speaker and it can be located at other locations, such as at end or on one of the faces etc. The protective case (sleeve) of the present invention is thus constructed in view of the specific location of the speaker.

In accordance with one embodiment, the protective case is constructed to mate with the mobile device such that the case is removably coupled (attached) to the mobile device. For example, a snap fit or friction fit or some other type of mechanical fit can be formed between the case and the mobile device.

The protective case thus has a construction that is complementary to the mobile device to permit the reception of the mobile device within the hollow interior of the protective case.

The protective case is thus formed of a body 110 that can have a first end, an opposing second end, a first side 116, a second side 118 a bottom wall or floor that is formed between the ends and sides. The ends upstanding structures relative to the floor. The floor has an inner surface or face that faces the mobile device when the case is mated to the mobile device and an opposite outer surface or face that faces away from the mobile device. As shown, the case has a generally hollow construction. In accordance with the present invention, the case is constructed such that it not only receives and mates to the mobile device but is also includes a sound amplification space that is formed between the mobile device and the case for acoustically amplifying the sound emitted from the internal speaker. More specifically and in accordance with one embodiment of the present invention, the sound amplification space is located along the floor of the case. However, the placement of the mobile device within the case does not interfere or otherwise impinge upon the space. As a result, in one embodiment, the floor has at least one structure or spacer that serves to create and define the space along the floor and serves to space and elevate the mobile device relative to the floor such that when the case is mated to the mobile device, the back face of the mobile device is not in intimate contact with the floor 120. As a result of the mobile device being spaced (elevated) from the floor, the sound amplification space is formed and defined between the mobile device and the floor.

As shown in the figures, there can be a plurality of distinct spacers that are formed in select areas along the floor. The spacer(s) is formed such that when the mobile device is inserted into the protective case, the mobile device is supported in a level manner and therefore, the spacer or spacers are typically located at or near both ends of the protective case, thereby supporting the mobile device in a level manner.

It will also be appreciated and understood that the one or more structures (spacers) can be formed of any number of different shapes; different dimensions and be formed of different materials. Exemplary materials include but are not limited to synthetic (polymeric) materials (plastic materials) and natural materials, such as rubbers, etc. For example, each spacer can be in the form of rubber strips, rails, pads, blocks or be in the form of synthetic (e.g., silicone) strips, rails, pads, blocks, etc. Other materials from which the case (as well as the other cases described herein) can be formed include but are not limited to metal, composite, fiberglass, graphite, carbon fiber, wood, a fiber material, etc.

It will be appreciated that the shape of the sound amplification space depends on the shape and size of the one or more spacers that are disposed along the floor.

It will also be understood that the spacer can be integrally formed with the case at the time of manufacture (e.g., during a common molding process) or the spacer can be applied subsequently to a preformed protective case.

With respect to the mobile device that has the speaker at the second end, the protective case is constructed such that the second end thereof mates with the second end of the mobile device. However, the second end of the case is constructed such that it is not in intimate contact with the speaker but rather the second channel has a space or channel that is in communication with the space that is formed along the floor. This allows the sound emitted from the internal speaker to travel (be channeled) along the end of the protective case to the space where sound amplification results. The top edge of the end of the case can thus be in intimate contact with the top edge of the end of the mobile device, with the channel being formed below the top edge and not visible externally.

When the case is formed of a flexible material (such as rubber or a polymeric material, etc.), the areas that define the space can be easily compressible by the user until the floor is brought into contact with the mobile device. However, the material used to form the flexible case functions as memory material and returns to its original state when the applied force is removed.

The channel can have any number of different shapes and serves a similar or identical function of the space in that the channel is in communication with the internal speaker and receives sound therefrom and amplifies said sound.

The protective case also has at least one sound output or opening formed therein. The opening is open to the exterior and is in communication with the sound amplification space and thus, serves as an exit (outlet) for the amplified sound. The opening can be formed in any number of different locations of the case. For example, the opening can be formed in one end and/or in one side and/or in the floor (bottom wall). The figures attached hereto show various locations for the opening. In addition, it will be appreciated that the opening can also have an additional purpose besides as a sound outlet and more particularly, the opening can include a control button and/or a port and/or a jack, etc.

Also, the case can have more than one opening formed therein to allow multiple outlets for the sound to exit the case.

Additional details, including optional features, of the present invention are set forth in the accompanying figures and in particular, are described in the text associated with the figures.

The present invention thus provides a means for amplifying sound by providing an integral sound amplification space that is at least partially and in most cases substantially located below the rear of the device. The protective case is constructed such that it provides a barrier in front of the speaker so as to effectively capture the sound emitted therefrom and direct it into the sound amplification space for amplification thereof. Amplified sound is emitted at any number of different locations along the protective case. In other words, the case is constructed such that a portion of the case covers the speaker so as to prevent the sound emitted therefrom from freely pass out to the user. Instead, as described herein, the portion of the case that covers the speaker directs the emitted sound to the sound amplification space where amplification is performed.

As mentioned above, the above case is designed to snap fit or otherwise be attached to the mobile device; however, in a rest state, the sound amplification space is maintained and in particular, when the user grips the case by the sides thereof or ends thereof, the sound amplification space is at least substantially maintained in terms of its structures and serves to amplify the sound that is emitted from the internal speaker.

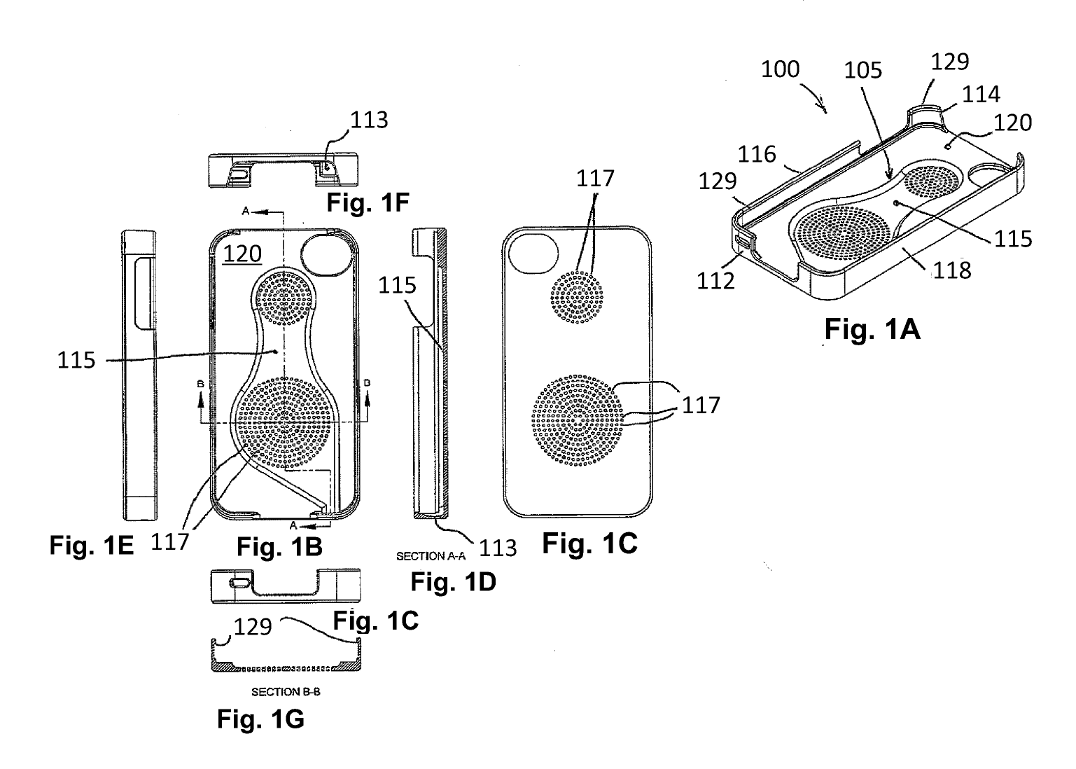

FIG. 1 includes a number of different views of a protective case 100 formed in accordance with one embodiment of the present invention. The case 100 is thus formed of a body 110 that can have a first end 112, an opposing second end 114, a first side 116, a second side 118, a bottom wall or floor 620 that is formed between the ends 112, 114 and sides 116, 118. The ends 112, 114 and sides 116, 118 are upstanding structures relative to the floor 120. The floor 120 has an inner surface or face that faces the mobile device when the case 100 is mated to the mobile device and an opposite outer surface or face that faces away from the mobile device 100. As shown, the case 100 has a generally hollow construction. In accordance with the present invention, the case 100 is constructed such that it not only receives and mates to a mobile device but is also includes a sound amplification space 105 that is formed between the mobile device and the case 100 for amplifying the sound emitted from the internal speaker of the device, such as speaker. More specifically and in accordance with one embodiment of the present invention, the sound amplification space 105 is located along the floor 120 of the case 100. However, the placement of the mobile device within the case does not interfere or otherwise impinge upon the space 105.

In the embodiment of FIGS. 1A-1H, the floor 120 includes a recessed area 115 that defines in part the sound amplification space 105. As shown the recessed area 115 can have an irregular shape or can have a regular shape and in the illustrated embodiment, the recessed area 115 occupies a majority of the surface area of the floor 120. The end 112 also includes a recessed section 113 that extends to the floor 120 and in particular, there is registration between the recessed section 113 and the recessed section 115 as a result of the recessed section 113 opening into the recessed section 115. Sound emitted from the internal speaker of the device is thus channeled downward within the section 113 and into the recessed section 115 that lies below the device (which seats against the elevated portion of the floor 120).

In the illustrated embodiment, the recessed section 115 tapers inwardly toward the first end 112 and is in registration with the recessed section 113 at the end 112. The middle section of the recessed section 115 defines a maximum width and then the recessed section 115 tapers inwardly toward but not to the second end 114.

Within the recessed section 115, a plurality of openings (e.g., pin holes) 117 is formed to allow the sound amplified within the section 115 to be emitted from the case 100 by passing through the openings 117. While two circular shaped patterns of openings 117 are shown (as is conventional in speaker design), any number of other patterns can be used. However, all of the pin holes are formed in the recessed section 115.

The case 100 includes other openings, notches, slots, etc., to accommodate buttons and power connections of the mobile device and allow such parts to be accessible to the user.

As with the other cases disclosed herein, the case 100 is constructed such that as a result of the mobile device being spaced (elevated) from the floor 120, the sound amplification space 105 is formed and defined between the mobile device and the floor 120. The advantages of such a design as described in detail with respect to the other embodiments described herein. In particular, the sound from the internal speaker of the device is deflected below (behind) the device by being channeled within recessed section 113 and recessed section 115 which is directly below (behind) the device, whereby sound amplification occurs in this space and the sound then exits through one or more openings, such as pin holes 117.

The ends and sides of the case 100 can include a top lip 129 to assist in mating and securing the case 100 to the mobile device. The case 100 also has a substantially open second end 114 as shown to accommodate certain mobile devices.

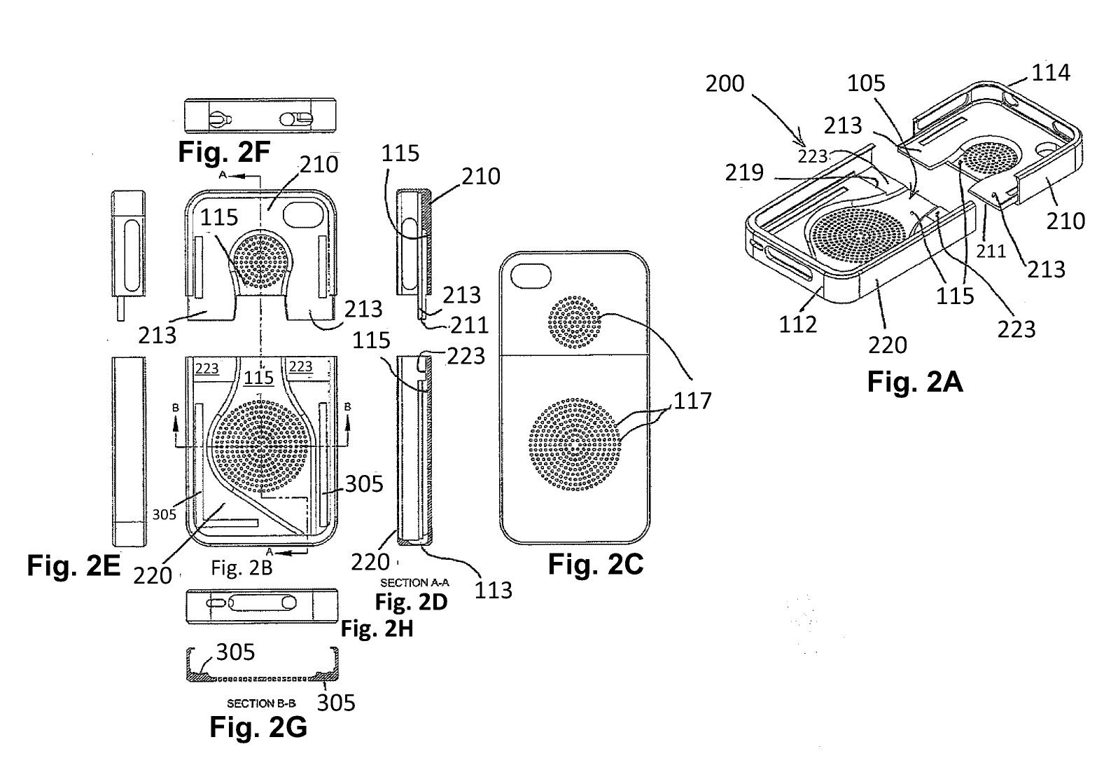

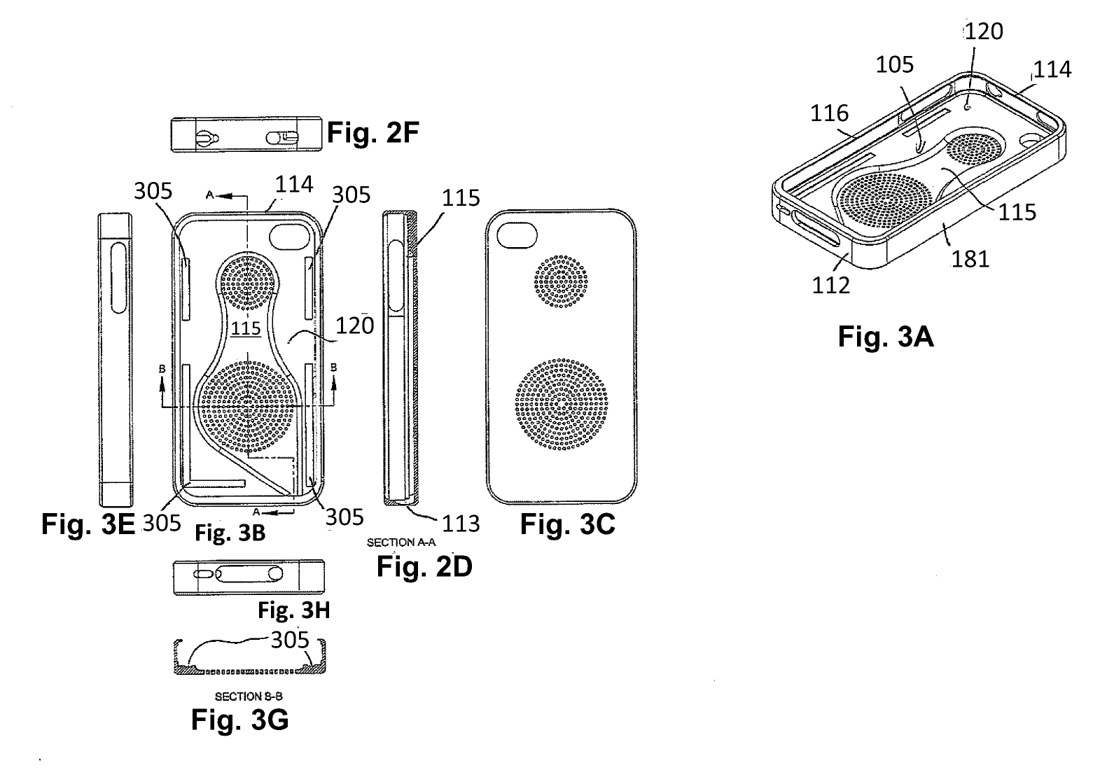

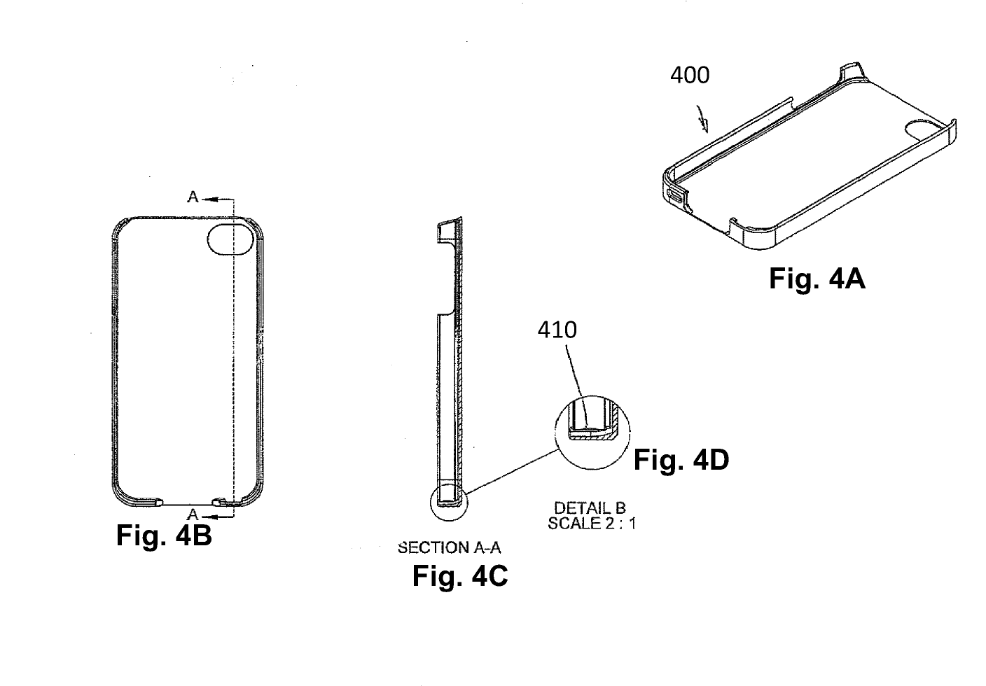

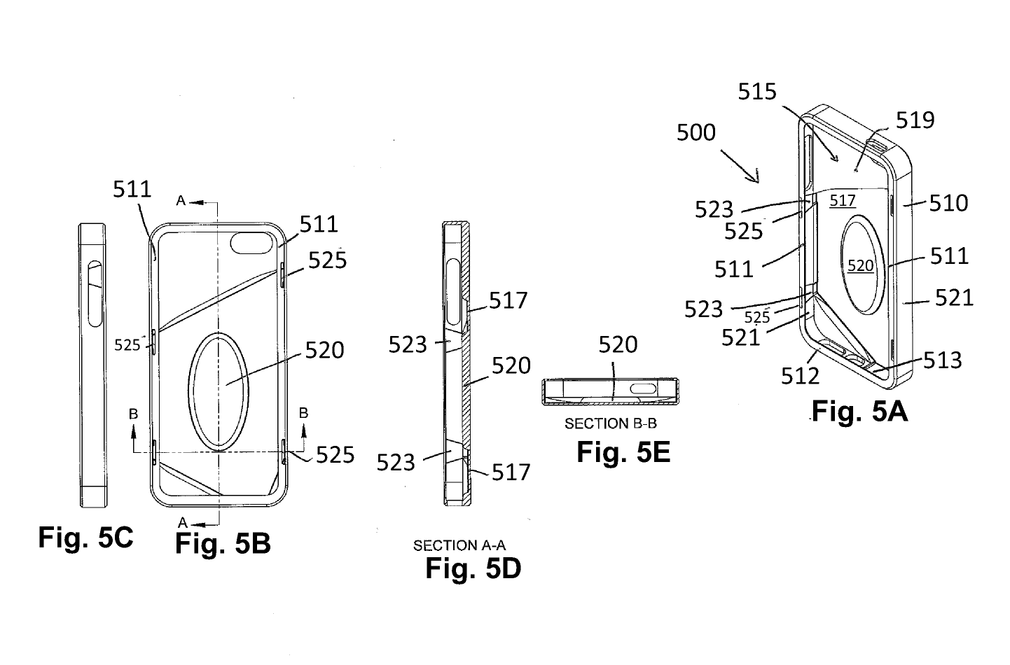

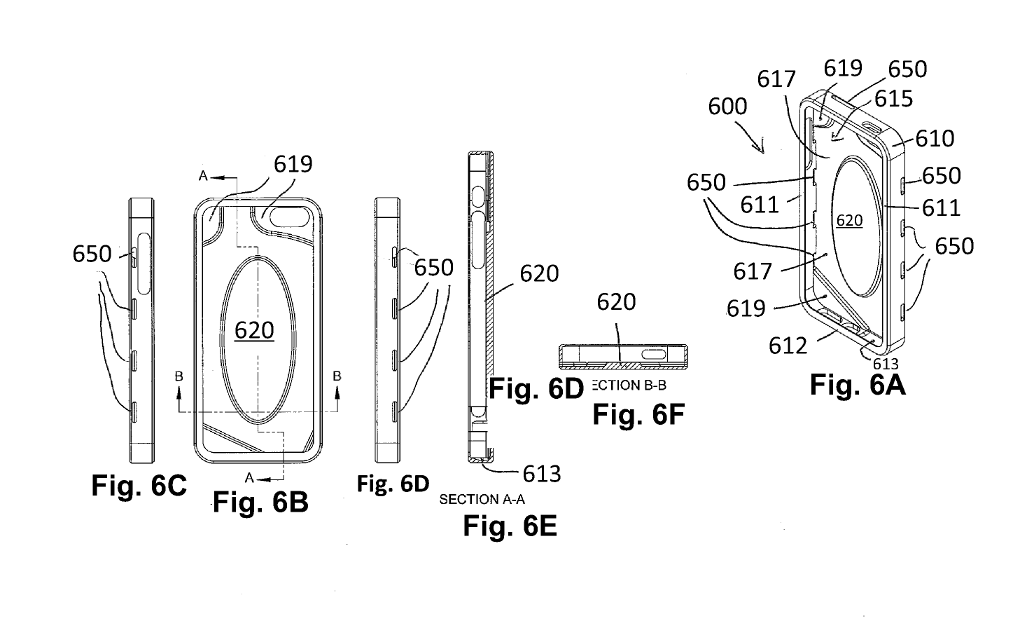

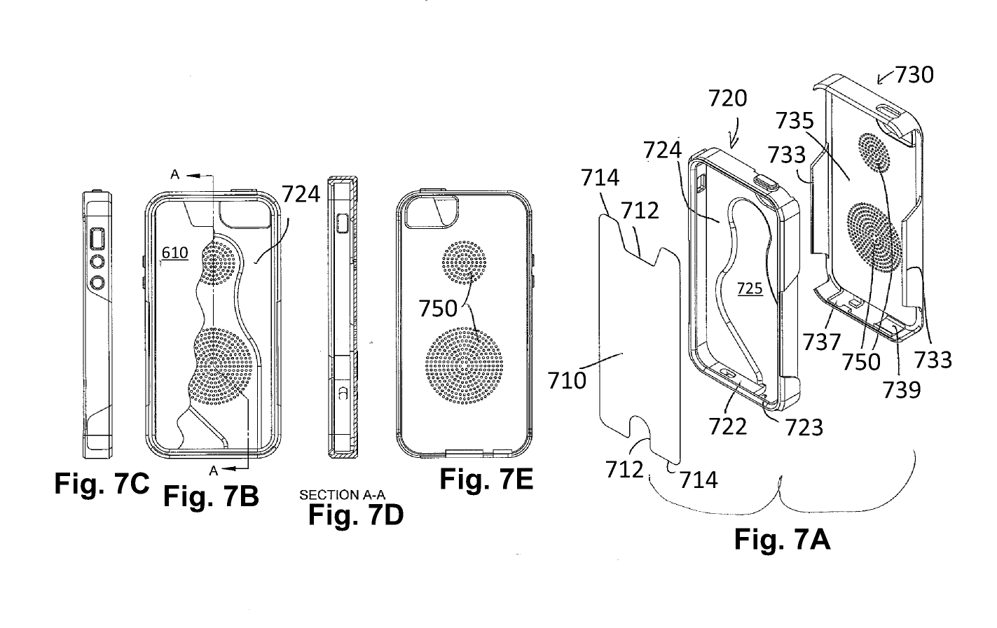

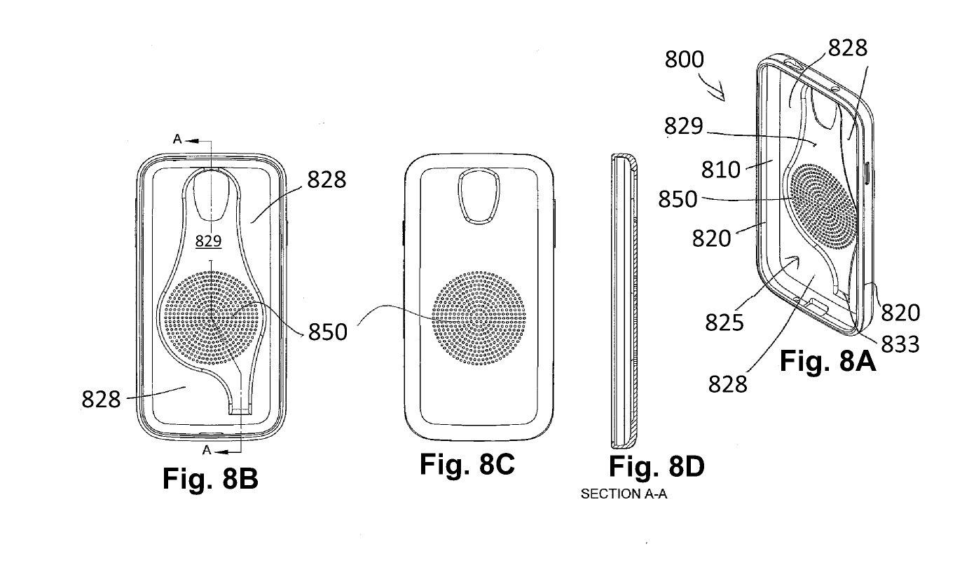

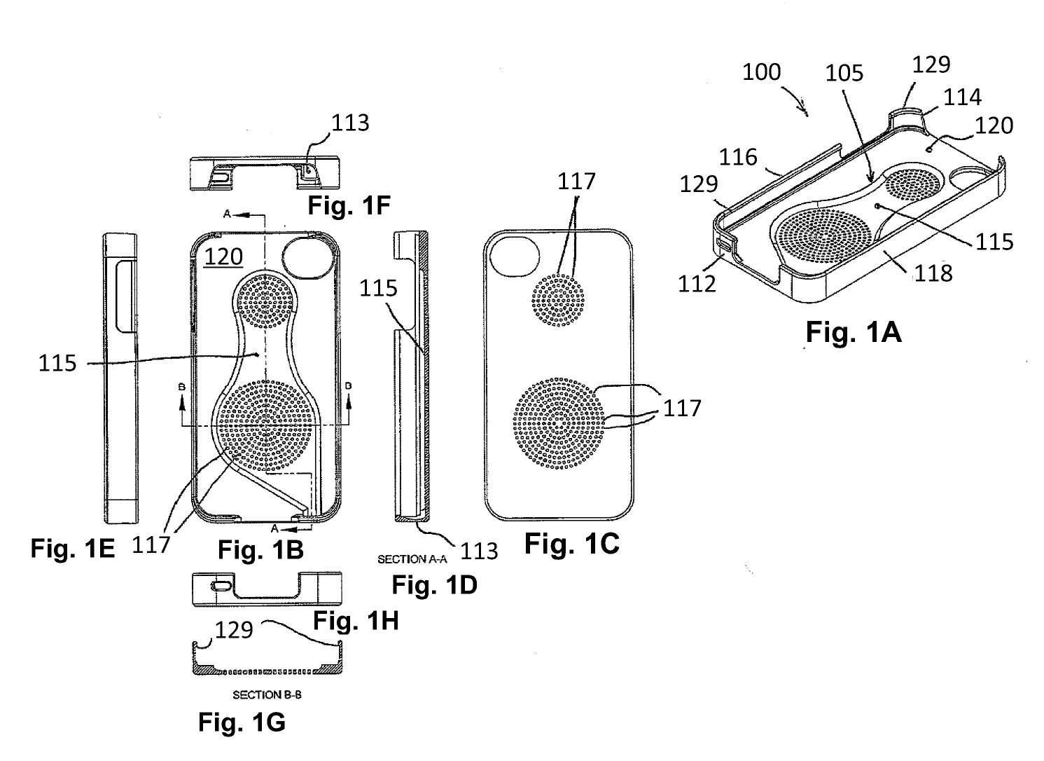

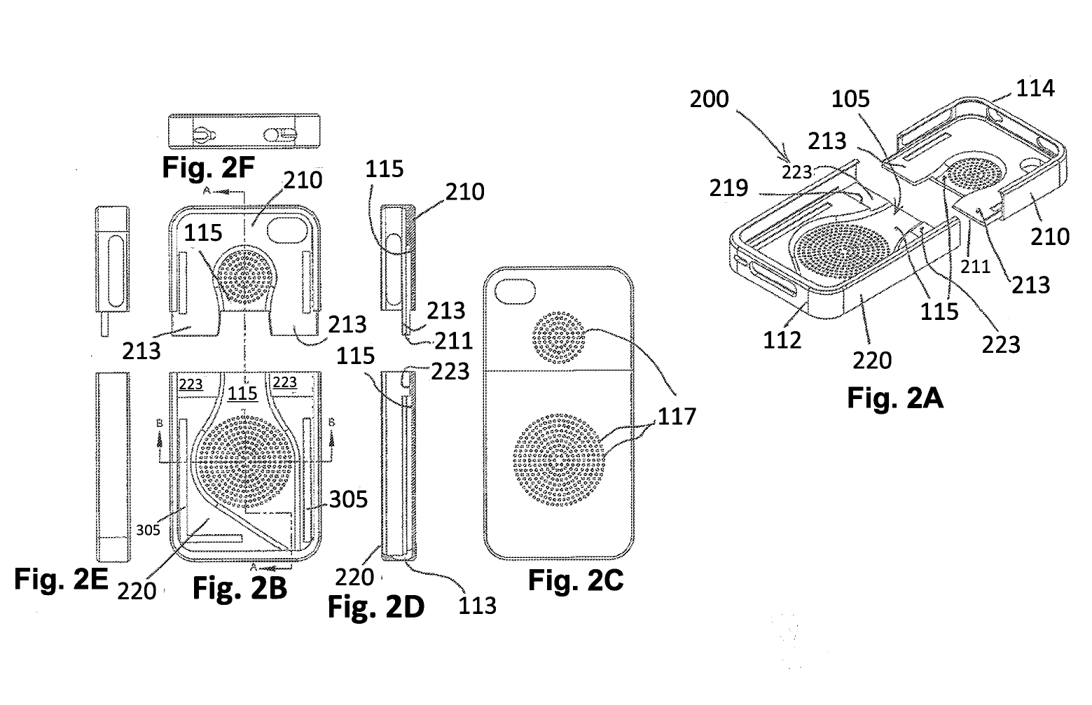

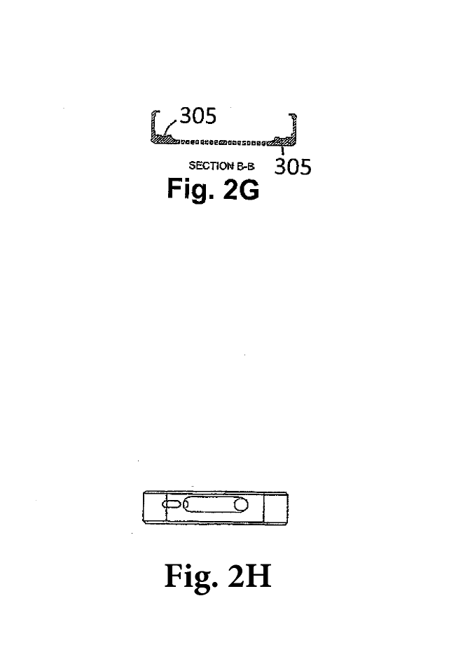

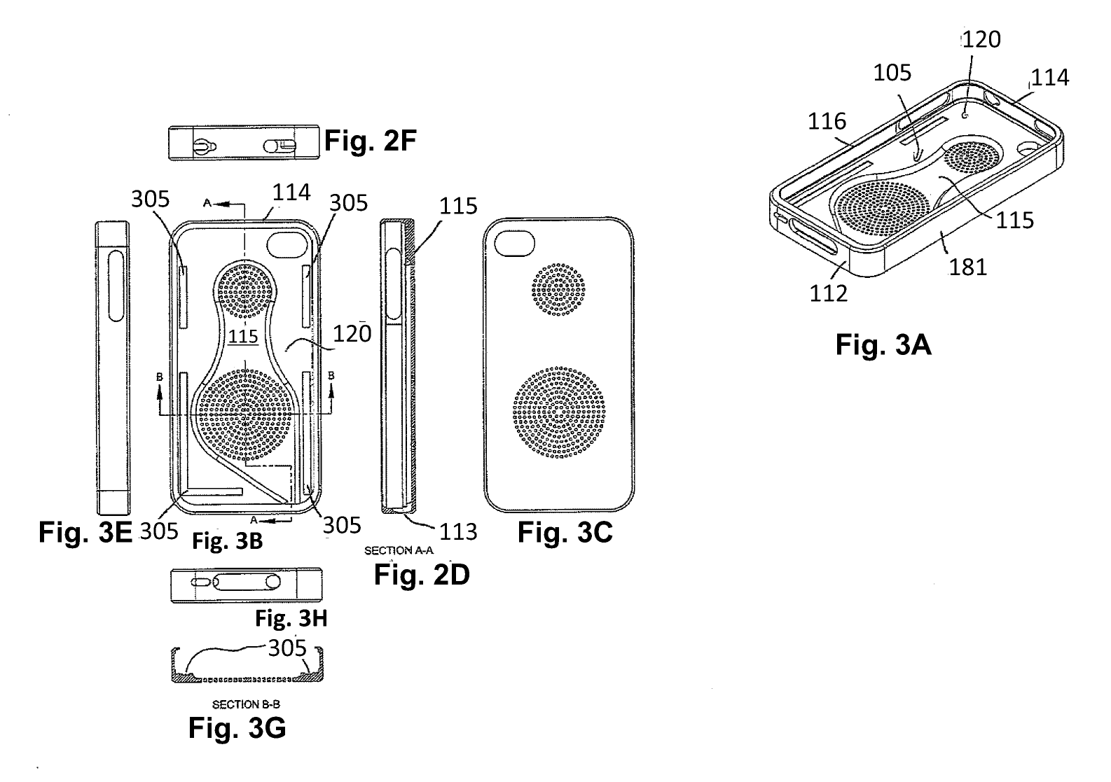

Now turning to FIGS. 2A-H in which a protective case 200 is shown. The case 200 is similar to case 100 and therefore like parts are numbered alike. In particular, the case 200 includes the sound amplification space 105 that is defined by recessed sections 113, 115. The main difference between case 200 and case 100 is that the case 200 is formed of two separate parts, namely a first part 210 and a second part 220, that mate together to form the assembled case 200. In particular, the first and second parts 210, 220 are constructed to slide together to form the assembled case 200. The break between the first and second parts 210, 220 extends transversely across the cover 200 and bisects the recessed section 115 formed in the floor 120.

The first part 210 has a free end 211 that includes a pair of floor extensions 213 that protrude outwardly from the free end 211, with the top surface of the floor extensions 213 being planar with the top surface of the floor 120 of the first part 210. The floor extensions 213 thus define, in part, side walls of the recessed section 115 and are located on either side of the recessed section 115.

The second part 220 has a complementary shape and is thus, configured to mate with the first part 210 to form the assembled structure. The second part 220 includes a free end 211. The floor 120 of the second part 220 has a stepped construction in that the floor 120 has a recessed portion 223 at the free end 211 on either side of the recessed section 115 that is formed in the second part 220 as shown. A shoulder 219 is formed between the recessed portion 223 and the rest of the floor 120 of the second part 220. The dimensions of the floor extensions 213 and the recessed portions 223 are such that the floor extensions 213 fit over and seat within the recessed portions 223 such that an underside of the floor extensions 213 seat against the top surface of the recessed portions 223. The free end 211 of the floor extensions 213 seat against the shoulder 219 when the first and second parts 210, 220 are mated together.

When installed, the device sits on the floor 120 above the recessed section 115 (and thus above the sound amplification space 105). The sound amplification occurs in the same manner as described above with respect to the other embodiments.

In addition, the floor 120 includes additional recessed sections 300 in the form of a plurality of elongated recessed sections 305 (e.g., linear recessed sections) that are located between the recessed section 115 and a respective side wall or end wall of the case. The recessed sections 305 are designed for receiving optional gaskets (e.g., rubber gaskets) to provide additional contact or grip members that provide traction and prevent the case from sliding and separating from the mobile device. The optional gaskets thus provide additional gripping surfaces that contact the device and hold it in place in the case. Any number of suitable materials can be used for forming the optional gaskets, such as rubber, synthetic polymers, foam, etc.

Now turning to FIGS. 3A-H in which a case 300 is shown. Case 300 is very similar to case 100 and therefore like components are numbered alike. One difference is that the ends and sides have more of a continuous wall structure in the case 300 compared to the case 100.

In addition, the floor 120 includes additional recessed sections 305 in the form of a plurality of elongated recessed sections 305 (e.g., linear recessed sections) that are located between the recessed section 115 and a respective side wall or end wall of the case.

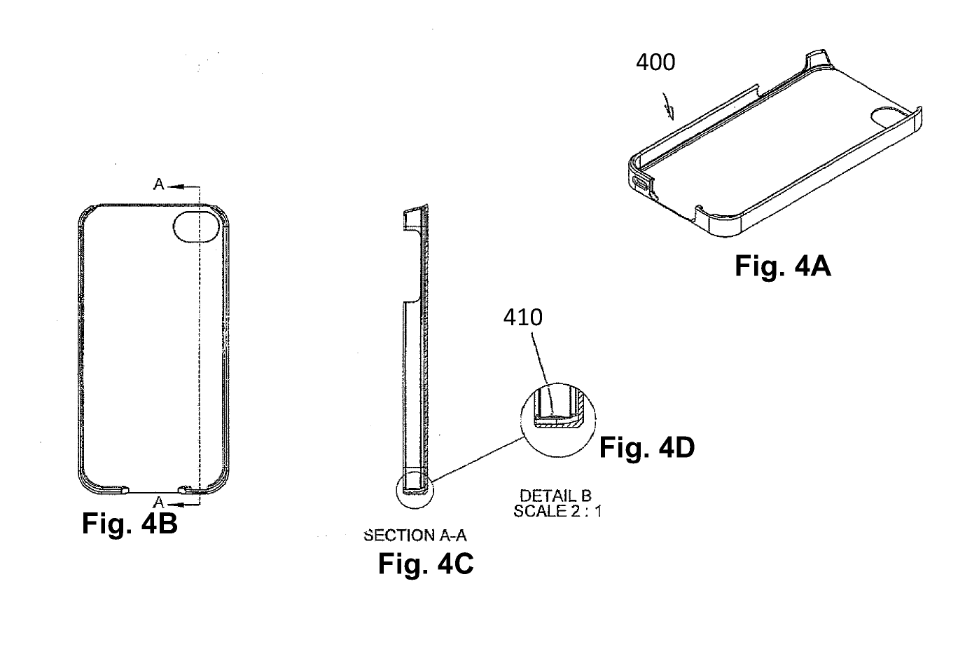

FIGS. 4A-D shows a case 400 in accordance with another embodiment. The case 400 is a different type of case that includes a lip 410 in front of the speaker of the device. Instead of deflecting the sound behind the phone as in the embodiments of FIGS. 1-3, the sound is deflected directly forward at the person operating the device. Sound improvement results due to increased sound volume being projected to the phone user.

It will also be appreciated that each of the cases disclosed herein can be made of vibrative or non-vibrative materials. In addition, the sound amplification space (sound void) offers better sound quality and offers the phone addition protection. The design and construction of the case thus increases the sound through acoustics and/or vibrations. The sound void (sound amplification space) can be hollowed out from the plastic material that makes up the case.

A smartphone case that is made up of 2 or more pieces which the pieces are assembled on the phone in order to protect the phone and create a void for sound to pass, capture the sound discharged from the phone and amplified throughout some opening in the case regardless of whether the opening is on the top, bottom, sides, back, front of the case. There will be a protective hard or soft shell that will snap together with clips, buttons, straps, or held together by pressure created by the material sliding together or held together by the exterior protective shell. This exterior protective shell will engulf other components of case and phone to increase protection. It will also help create a void for the sound to travel from the speaker, amplify, and discharge from openings on the case.

The device can be exemplary three piece case assembly. The three piece case is made up of a protective (front) face plate, a protective back piece (case), and protective sleeve (cover) that encapsulates (surrounds) the other pieces.

The face plate 1010 that covers and protects the front face of phone can be formed of a hard or soft material. This can attach to the phone by means of pressure, clips, straps, and/or buttons or by any other suitable mechanical fastener. The face plate is a generally or substantially planar structure.

The protective back case can fasten to the face plate by any suitable means, including those mechanical fasteners listed above. The protective back case can be hard rigid or soft flexible material. The protective case has a floor and upstanding walls surrounding the floor. The protective case also includes an opening formed in the floor to create space for a sound void. This sound void will allow for the sound from phone speaker to travel and discharge from overall assembly as described herein. The size and shape of the sound void can be customized in view of any number of different factors including but not limited to the type of mobile device, materials being used to form the case, the dimensions of the case, etc.

It will be understood that the face plate can be eliminated in some applications depending upon, in part, the type of phone that is being used, etc. In this embodiment, the case assembly is formed of two parts.

The material of the protective back case is open in front of music speaker. This allows for the sound produced by phone to discharge and to be channeled to the backside of the case where it can amplify and discharge from case. In other words, the end wall of the protective back case can include one opening to allow access to phone controls and includes a second opening (indicated by the arrow) that collects the sound from the speaker and channels it as discussed herein. One will note that the material forming this part continues around the top side of phone to allow material of case to be held around the phone by pressure.

The protective sleeve constitutes the bottommost structure of the assembly. The protective sleeve generally has a similar appearance and the protective back case in that it includes a floor and surrounding side walls that extend upwardly from the floor. As discussed herein, the floor can either be a planar surface or can include a recessed portion which is placed in registration with the opening formed in the protective back case. In the case of using a recessed floor, the recess in the floor further defines the acoustic (amplification) chamber (gap) in that it increases the overall size (e.g., depth) thereof.

When assembled with the other parts (i.e., the face plate and protective back case), the protective sleeve surrounds and captures the other parts. In particular, when the face plate is used, the phone is in effect sandwiched between the face plate and the protective back case to which the face plate is attached (thereby forming a sub-assembly), and the protective sleeve surrounds this sub-assembly. The arrows in the figure indicate examples of where holes can be formed in the floor to allow the sound to escape from the assembly. The holes can be formed to have any number of different shapes and/or sizes. The holes can also be formed in view of speaker style and can take any number of different forms including slots, open holes, perforated skin, etc., so long as they are intended to let sound pass therethrough.

It will be appreciated that the opening formed in the protective back case can have a similar shape as the structure in which the openings are formed therein in the sleeve. From the rear, the speaker openings can have a much different design relative to the opening in the protective back.

It will therefore be understood that the protective back case acts as a spacer so as to define an acoustic space on the backside of the phone. In other word, as shown, when the parts are assembled, a bottom surface of the floor of the protective back case seats against a top surface of the floor the protective sleeve. The thickness of the floor of the protective back case thus, in part, defines the distance that the mobile device is spaced from the protective sleeve.

One will appreciate that the end wall is solid in front of the speaker of the phone. The sound discharges from the phone and is redirected off this wall as in other styles in this file.

It fits tightly around the edge of phone from pressure from material or clips except that there is an opening formed in the protective back case at or near the location of the music speaker of the mobile device and/or on the back side and/or area of the phone where the sound gap (amplification chamber) will be established. There can be holes formed in the end wall to allow the sound to escape.

Different layers of material can be used to surround the phone. The different layers of material allow the sound gap (amplification chamber) to be created. The material covers the speaker of the phone with a lip that will deflect the sound throughout the phone as it is amplified and expelled. The amplification process for this case is similar to the previous embodiments described herein.

The exterior protective cover is constructed such that it includes a space formed in the body of the sleeve to allow the raised structure of the protective back case to protrude through so materials are flush. The body of the exterior protective cover is coupled to the protective back case by any number of ways (e.g., mechanical attachment), including but not limited to a snap fit (i.e., being snap fit around the protective back case), being held by pressure, or by fasteners or other mechanical connectors.

It will also be understood that: (1) the sound void can be dual function and shaped to be used as a compartment to hold credit cards or cash etc.; and (2) a stand that folds out of back side of phone case that supports the phone and opens the case to allow that sound to escape.

As mentioned, any number of different materials can be used to make the product described herein including but not limited to natural materials, synthetic materials, plastics, metal, wood, etc.

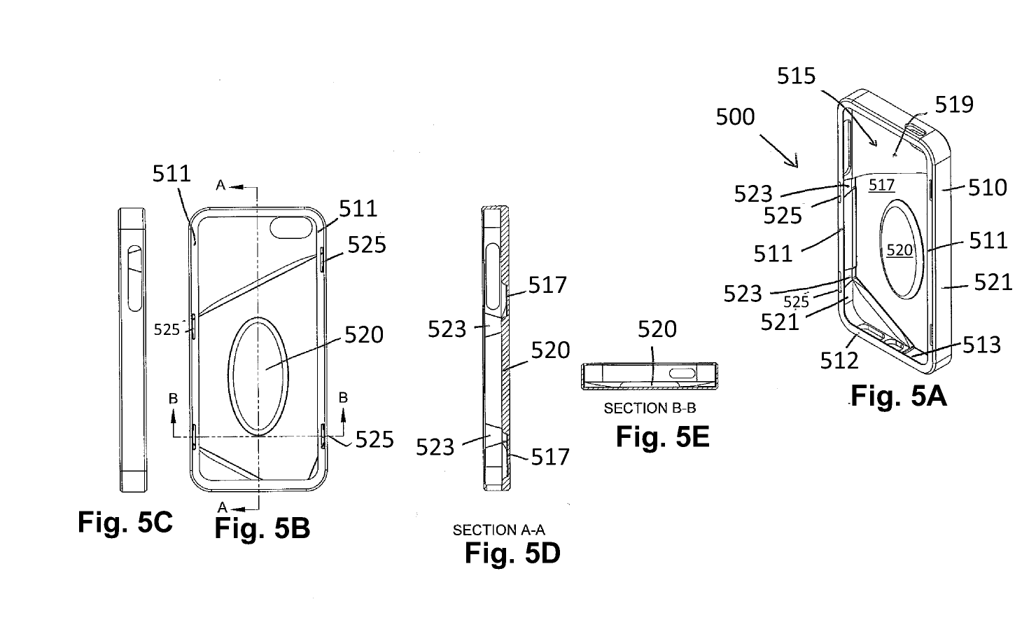

FIGS. 5A-5E illustrate another protective case 500. The protective case 500 is similar to the other embodiments and includes a sound amplifying space that channels and amplifies the sound from the speaker of the mobile device. The case 500 has a body 510 that is configured to mate with and be attached to the mobile device for protection thereof. The body 510 includes a peripheral lip (flange) 511 that extends around the body and seats proximate the top face of the mobile device. An end wall 512 that is for placement against the side (edge) of the mobile device that contains the speaker. The wall 512 includes a channel (recessed section) 513 formed in the wall 512 for directing the emitted sound downwardly towards the rear of the mobile device and the floor 515 of the body 510. The floor 515 includes a recessed section 517 that is recessed relative to a surrounding portion 519 of the floor 515. The recessed section 517 is in communication with the recessed channel 513 and thus emitted sound travels through the channel into the recessed section 517 which forms a sound amplification space below the mobile device which seats against the portion 519 of the floor. Sound within the recessed section 517 that travels to one or more outlets (openings) through which the sound travels out of the case in amplified form.

The case 500 has at least one raised section (an island) 520 formed in the recessed section 517, with the top surface of the section 520 lying in the same plane as the top surface of the portion 519 of the floor. The installed mobile device thus seats against the section 520 and portions 519.

The body 510 has a plurality of outlets 550 through which the amplified sound exits. In this embodiment, side walls 521 includes recessed channels 523 formed therein that are in communication with the recessed section 517 to allow the amplified sound to travel into the recessed channels 523 (which create a space between the wall 521 and the side of the mobile device. The amplified sound travels in the channels 523 to an outlet (opening) 525 that is formed in the peripheral lip 511. As shown, there can be one outlet 525 for each channel 523.

In this design, the sound thus first travels downward toward the floor of the case into the recessed section 517 where it is amplified in this space between the back of the mobile device and the floor and then travels into the side channels 523 before flowing up and out of the outlets 525, which direct the amplified sound forward (from the front face of the mobile device).

Other openings shown are for the controls, etc. of the mobile device.

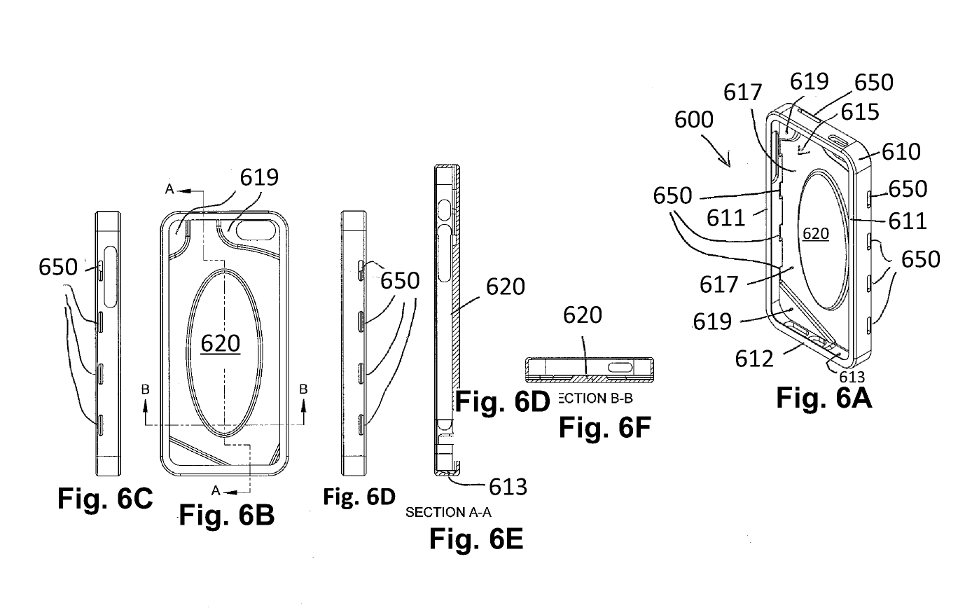

FIGS. 6A-5F illustrate another protective case 600 that is similar to the protective case 500. The case 600 has a body 610 that is configured to mate with and be attached to the mobile device for protection thereof. The body 610 includes a peripheral lip (flange) 611 that extends around the body and seats proximate the top face of the mobile device. An end wall 612 that is for placement against the side (edge) of the mobile device that contains the speaker. The wall 612 includes a channel (recessed section) 613 formed in the wall 612 for directing the emitted sound downwardly towards the rear of the mobile device and the floor 615 of the body 510. The floor 615 includes a recessed section 617 that is recessed relative to a surrounding portion 619 of the floor 615. The recessed section 617 is in communication with the recessed channel 613 and thus emitted sound travels through the channel into the recessed section 617 which forms a sound amplification space below the mobile device which seats against the portion 619 of the floor. Sound within the recessed section 617 that travels to one or more outlets (openings) through which the sound travels out of the case in amplified form.

The case 600 has at least one raised section (an island) 620 formed in the recessed section 617, with the top surface of the section 620 lying in the same plane as the top surface of the portion 619 of the floor. The installed mobile device thus seats against the section 620 and portions 619.

The body 610 has a plurality of outlets 650 through which the amplified sound exits. In this embodiment, side walls 621 include outlets 650 that are formed in locations of the side walls that are immediately adjacent the recessed section 617. An opposite end wall 629 that is opposite wall 612 also includes an outlet 650 that is formed immediately adjacent the recessed section 617.

The locations of the outlets 650 allow the amplified sound to exit in amplified form (after being amplified in the sound amplification space defined by section 617).

In this design, the sound thus first travels downward toward the floor of the case into the recessed section 617 where it is amplified in this space between the back of the mobile device and the floor and then travels out of the outlets 650 since all outlets 650 are in direct communication with the recessed section 617 (formed below the mobile device), which direct the amplified sound out of the sides and end of the case.

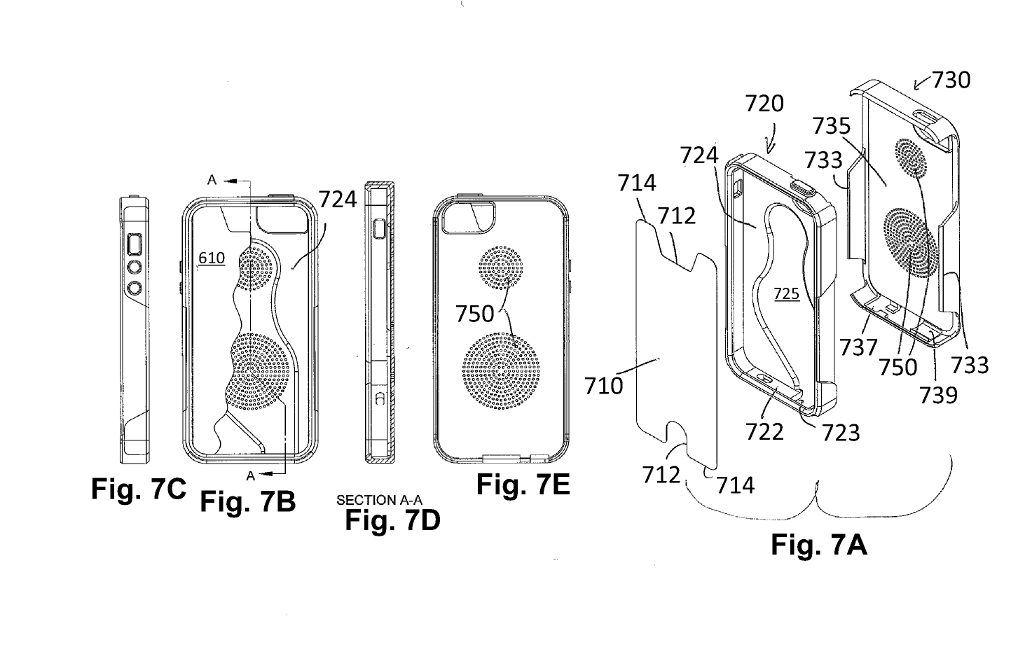

FIGS. 7A-E illustrate a case 700. The case 700 is similar to some embodiments described herein and is formed of multiple parts that form an assembly. The case 700 includes a first part 710, a second part 720 and a third part 730. The assembly of these three parts defines the sound amplification space below the mobile device. The first part 710 is a plate like structure having a pair of slots 712 formed therein. Slots 712 can be formed and open along ends 714 of the part. The second part 720 has a peripheral wall structure that extends around a floor 724. An end wall 722 of the peripheral wall structure is for placement against the side (edge) of the mobile device that contains the speaker. The wall 722 includes a channel (recessed section) or notch (as shown) 723 formed in the wall 722 for directing the emitted sound downwardly towards the rear of the mobile device and the floor 724. The floor 724 includes an opening 725 formed therein. Surrounding portions 726 of the floor 724 are thus elevated and define a surface against which the mobile device seats. The opening 725 is in communication with the notch (opening) 723 and thus sound traveling in notch 723 from the speaker of the mobile device travels to and through the opening 725. The second part can include other openings and the like to accommodate the controls of the mobile device.

The first part 710 seats against the floor 724 to cover the opening 725. The slots 712 are spaced from the notch 723 to cause emitted sound to only travel below the first part to the opening 725.

The third part 730 mates with the second part 720 to form an assembled case. The third part 730 has a body that has side walls (or sections) 733 for mating with the side walls of the second part to attach the third part 730 to the second part 720. As shown the outer surface of the side walls of the second part can include recessed areas that receive the side walls of the third part in a snap-fit manner. A floor 735 of the third part 730 includes an outlet 750 that is in registration with the opening 725 to allow sound exit through outlet 750. In particular, the sound amplification space is defined between a top surface of floor 735 and the bottom surface of the first part 510. An end wall 737 seats against end wall 722 and includes a section 739 that closes off the notch 723 but defines the sound channel which receives the emitted sound from the speaker and directs it down to the opening 725.

In this design, the sound thus first travels downward toward the floor of the case into the opening 725 where it is amplified in this space between the first and third parts 710, 730 and then travels out of the outlets 750 since all outlets 750 are in direct communication with the sound amplification space (formed below the mobile device), which direct the amplified sound out of back (rear) of the case.

As shown the outlet 750 is in the form of a pattern of small openings that are in registration with the sound amplification space (lie below opening 725).

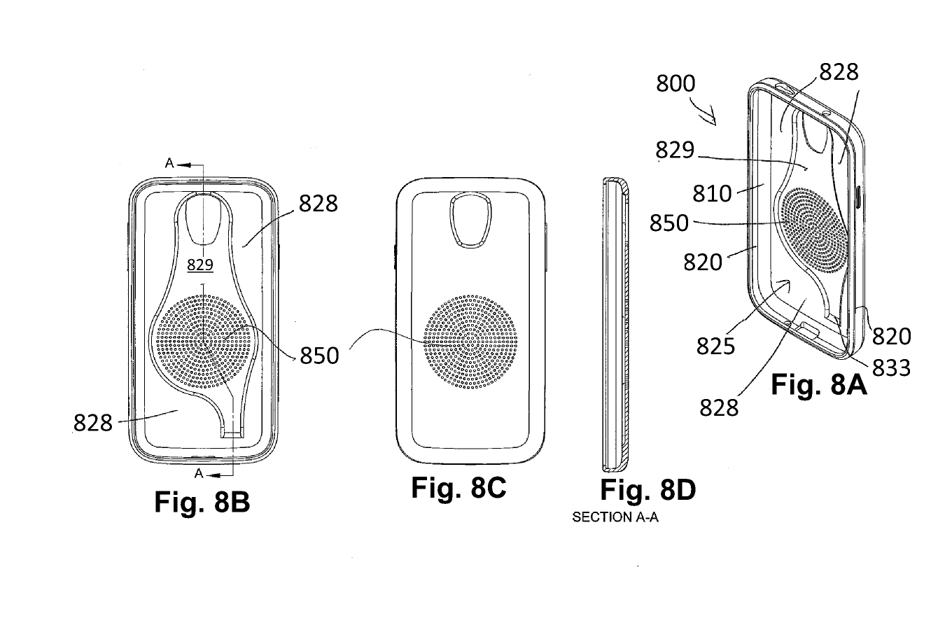

FIGS. 8A-D illustrate a case 800. Case 800 is formed of a body 1410 that includes a peripheral side wall 820 and a floor 825. The floor 825 includes a recessed section 829 and surrounding sections 828 that are elevated to the recessed section 829. The recessed section 829 has a pattern that has a portion 833 that is adjacent the speaker of the mobile device (a rear speaker). Within the recessed section 829 there is an outlet 850. Outlet 850 can be in the form of a series of small openings through which sound exits the case below the mobile device. Other openings in the case and floor accommodate controls and camera of the device.

The cases of the present invention provide a number of advantages including but not limited to: (a) even though the case has a built in acoustic chamber it includes a protective lip around face of phone offering the same protection for the phone as any standard phone protection case; (b) unlike previous design by others the improved case of present invention is streamlined and not overbearing and cumbersome. It is discreet and comfortable and makes it so that the phone easily fits into a pocket; (c) unlike previous design the present case captures, diverts and focuses the sound from the phones speaker through our (basically) sealed chamber and through acoustically favorable, strategically placed and patterned holes in the back, side, or front of the case. These holes and slim case design style causes sound to remain in a closed space between the case and phone/tablet which reduces diffraction of sound to ensure a higher quality of sound emitted from case. Optimal sound and quality are achieved through sound voids of about 1 mm-3.5 mm. Anymore ear piercing diffraction will occur; and (d) the multiple piece case is clearly a different way of building the acoustic cavity.

1. A protective case for a mobile device having an internal speaker comprising:
a body that is configured to receive and be removably coupled to the mobile device such that the body lies over select portions of the mobile device for protection thereof, the body having a floor that faces a rear of the mobile device;
at least one structure that extends outwardly from the floor and is elevated relative thereto for providing a platform to support the mobile device and to define a sound amplification space that is at least partially positioned below the mobile device when the mobile device is inserted and is configured to amplify sound emitted from the internal speaker of the mobile device; and
at least one opening formed in the body, the at least one opening being open to an exterior and in communication with the sound amplification space so as to provide an outlet for the amplified sound.

2. A protective case for a mobile device having an internal speaker comprising:
a body that is configured to receive and be removably coupled to the mobile device such that the body lies over select portions of the mobile device for protection thereof, the body having a floor that faces a rear of the mobile device, wherein the floor at least in part defines a sound amplification space that is at least partially positioned below the mobile device when the mobile device is inserted and is constructed to amplify sound emitted from the speaker of the mobile device; and
at least one opening formed in the body, the at least one opening being open to an exterior and in communication with the sound amplification space so as to provide an outlet for the amplified sound.

3. A protective case for a mobile device having an internal speaker comprising:
a body that is configured to receive and be removably coupled to the mobile device such that the body lies over select portions of the mobile device for protection thereof, the body having a floor that faces a rear of the mobile device and an upstanding peripheral wall structure for placement against sides and ends of the mobile device, wherein at least one portion of the upstanding peripheral wall is for placement adjacent the internal speaker;
at least one structure that extends outwardly from the floor and is elevated relative thereto for providing a platform to support the mobile device and to define a sound amplification space that is at least partially positioned below the mobile device when the mobile device is inserted and is configured to amplify sound emitted from the internal speaker of the mobile device, wherein the at least one portion of the upstanding peripheral wall defining a space that communicates with the sound amplification space and is configured to direct the sound emitted from the speaker to the sound amplification space; and
at least one opening formed in the body, the at least one opening being open to an exterior and in communication with the sound amplification space so as to provide an outlet for the amplified sound.

4. (canceled)
